(19) United States
(12) Patent Application Publication
(10) Pub. No.: US 2018/0211309 A1
(43) Pub. Date: Jul. 26, 2018

(54) METHOD OF AUCTION

(71) Applicant: SHANGHAI BAOKU INFORMATION TECHNOLOGY CO., LTD., Jing'an District (CN)

(72) Inventors: Shaobin PENG, Jing'an District (CN); Naiyue WANG, Jing'an District (CN); Peng YUE, Jing'an District (CN)

(73) Assignee: SHANGHAI BAOKU INFORMATION TECHNOLOGY CO., LTD., Jing'an District (CN)

(21) Appl. No.: 15/641,660

(22) Filed: Jul. 5, 2017

(30) Foreign Application Priority Data
Jan. 24, 2017 (CN) 201710063008.6
Apr. 12, 2017 (CN) 201710238185.3
Apr. 12, 2017 (CN) 201710238788.3

(51) Int. Cl. G06Q 30/08; G06Q 30/02

(52) U.S. Cl. CPC G06Q 30/08; G06Q 30/0283; G06Q 30/0214

(57) ABSTRACT

A method of auction is disclosed. The method includes: detecting one or more auction prices from a plurality of second calculating devices within a pre-set time by a first calculating device; upon detection of at least one auction price, determining one of the plurality of second calculating devices as a successful bidder within the pre-set time; and repeating the foregoing steps until the item is sold or passed, wherein when the item is sold, the method further includes: giving a commission or a red envelope to each second calculating device that has been determined as a successful bidder within a corresponding pre-set time except the second calculating device to which the item is sold. The method enables a user to implement online item transaction through a second calculating device, thus lowering the threshold for a common user to participate in auction.

### CROSS-REFERENCES TO RELATED APPLICATIONS

This application claims the priorities of Chinese patent application number 201710063008.6 filed on Jan. 24, 2017 entitled “Method of Auction”, Chinese patent application number 201710238185.3 filed on Apr. 12, 2017 entitled “Method of Sharing Auction Information of Online Auction Items and Method of encouraging Sharing”, and Chinese patent application number 201710238788.3 filed on Apr. 12, 2017 entitled “Bidding Method”, the entire contents of which are incorporated herein by reference.

### TECHNICAL FIELD

The present invention relates to the field of auction, and more particularly to an auction method.

### BACKGROUND

Before an artwork auction begins, an auction company will conduct preview or even tour for a few days and print catalogues according to a traditional trading manner. In this process, the consumed cost is imaginable.

Due to geographical limitations to a spot auction, a foreign buyer needs to bear expenses such as transportation and accommodation and needs to spend lot of time in the auction, so lots of interested buyers cannot participate, thus reducing the audience scope.

At present, some online auction systems cannot provide online time-limited bidding service due to technical limitations. Moreover, the participation cost of auction is very high, and the participation enthusiasm of a user is not high.

### SUMMARY OF THE INVENTION

A first objective of the present invention is to provide an auction method, intended to increase the participation enthusiasm of a user for auction.

A second objective of the present invention is to provide an auction method, intended to share an auction item during online auction.

To achieve one or more of the foregoing objectives, the present invention provides an auction method, for auction of an item, comprising:

detecting, by a first calculating device, one or more auction prices from a plurality of second calculating devices within a pre-set time;

upon detection of at least one auction price, determining one of the plurality of second calculating devices as a successful bidder within the pre-set time; and

repeating the foregoing steps until the item is sold or passed, wherein

when the item is sold, the method further comprises: giving a commission or a red envelope to each second calculating device that has been determined as a successful bidder within a corresponding pre-set time except the second calculating device to which the item is sold.

According to an embodiment, an auction process of the item may comprise one or more of a fixed-price stage, a free-bid stage and a final-bid stage.

According to an embodiment, the auction method may further comprise:

allocating a grade value to each of the plurality of second calculating devices, and upon determining one of the plurality of second calculating devices as a successful bidder, reducing the grade value of the one of the plurality of second calculating devices.

According to an embodiment, during the fixed-price stage, the plurality of second calculating devices are only allowed to bid auction prices that are equally raised; and the determining step may comprise:

sorting, in a descending order of the grade values, all the second calculating devices that have bidden within the pre-set time;

if there is only one second calculating device corresponding to a highest grade value, the only one second calculating device corresponding to the highest grade value is determined as a successful bidder;

otherwise, further sorting the second calculating devices corresponding to the highest grade value according to a bidding time, and determining the second calculating device that bids soonest within the pre-set time and has the highest grade value as a successful bidder.

According to an embodiment, during the free-bid stage, the plurality of second calculating devices are allowed to bid auction prices that are equally or unequally raised; and the determining step may comprise:

sorting, in a descending order of auction prices, all the second calculating devices that have bidden within the pre-set time;

if there is only one second calculating device corresponding to a highest auction price, the only one second calculating device corresponding to the highest auction price is determined as a successful bidder;

otherwise, further sorting, in a descending order of grade values, the second calculating devices corresponding to the highest auction price;

if there is only one second calculating device corresponding to a highest grade value, the only one second calculating device corresponding to the highest grade value is determined as a successful bidder;

otherwise, further sorting the second calculating devices corresponding to the highest grade value according to a bidding time, and determining the second calculating device that bids soonest within the pre-set time and has the highest grade value as a successful bidder.

According to an embodiment, during the final-bid stage, the plurality of second calculating devices are allowed to bid auction prices that are equally or unequally raised; and the determining step may comprise:

sorting, in a descending order of auction prices, all the second calculating devices that have bidden within the pre-set time;

if there is only one second calculating device corresponding to a highest auction price, the only one second calculating device corresponding to the highest auction price is determined as a successful bidder;

otherwise, further sorting, in a descending order of grade values, the second calculating devices corresponding to the highest auction price;

if there is only one second calculating device corresponding to a highest grade value, the only one second calculating device corresponding to the highest grade value is determined as a successful bidder;

otherwise, further sorting the second calculating devices corresponding to the highest grade value according to a bidding time, and determining the second calculating device that bids soonest within the pre-set time and has the highest grade value as a successful bidder.

According to an embodiment, upon any one of the plurality of second calculating devices bidding an auction price that is equal to or greater than a final bid, the item is sold; or

upon expiry of a pre-set auction period, if at least one of the plurality of second calculating devices has bidden an auction price that is equal to or greater than a reserve price, and none of the plurality of second calculating devices has bidden an auction price that reaches a cap price, the item is sold; or

upon expiry of a pre-set auction period, if at least one of the plurality of second calculating devices has bidden an auction price that is equal to or greater than a cap price, and none of the plurality of second calculating devices has bidden an auction price that reaches a final bid, the item is sold; or

upon expiry of a pre-set auction period, if none of the plurality of second calculating devices has bidden an auction price that reaches a reserve price, the item is passed.

According to an embodiment, when the auction process comprises the fixed-price stage and the free-bid stage, upon any one of the plurality of second calculating devices bidding an auction price that is equal to or greater than a first pre-set price, the fixed-price stage ends and the free-bid stage starts.

According to an embodiment, when the auction process comprises the free-bid stage and the final-bid stage, upon any one of the plurality of second calculating devices bidding an auction price that is equal to or greater than a second pre-set price, the free-bid stage ends and the final-bid stage starts.

According to an embodiment, when the auction process comprises the fixed-price stage and the final-bid stage, upon any one of the plurality of second calculating devices bidding an auction price that is equal to or greater than a second pre-set price, the fixed-price stage ends and the final-bid stage starts. According to an embodiment, an amount of the commission or red envelope given to each second calculating device that has been determined as a successful bidder within a corresponding pre-set time except the second calculating device to which the item is sold is calculated according to:

Yᵢ=(Cᵢ−C_{cur})×wᵢ,

where i is a positive integer equal to or greater than 1, i represents an i^{th} second calculating device of the plurality of second calculating devices, Cᵢ represents an auction price bidden by the i^{th} second calculating device when the i^{th} second calculating device is determined as a successful bidder, Yᵢ represents an amount of commission or red envelope gained by the i^{th} second calculating device that has been determined as a successful bidder, C_{cur} represents a current price of the item before the i^{th} second calculating device bids Cᵢ, and w₁ represents a pre-set proportion.

According to an embodiment, when the item is sold,

if a highest auction price bidden among the plurality of second calculating devices is equal to or greater than the reserve price and is smaller than the cap price, an amount of payment by the second calculating device to which the item is sold is calculated according to:

C_{pay}=C₁,

where C_{pay} represents the amount of payment by the second calculating device to which the item is sold, and C₁ represents the highest auction price bidden among the plurality of second calculating devices;

if the highest auction price bidden among the plurality of second calculating devices is equal to or greater than the cap price and is smaller than the final bid, the amount of payment by the second calculating device to which the item is sold is calculated according to:

C_{pay}=C_{cap}+(C₁−C_{cap})×w₂,

where C_{pay} represents the amount of payment by the second calculating device to which the item is sold, C₁ represents the highest auction price bidden among the plurality of second calculating devices, C_{cap} represents the cap price, and w₂ represents a pre-set proportion.

According to an embodiment, if any one of the plurality of second calculating devices has bidden an auction price that is equal to or greater than a final bid, an amount of payment by the second calculating device to which the item is sold is calculated according to:

C_{pay}=C_{cap}+(C_{final}−C_{cap})×w₃,

where C_{pay} represents the amount of payment by the second calculating device to which the item is sold, C_{final} represents the final bid, C_{cap} represents the cap price, and w₃ represents a pre-set proportion.

According to an embodiment, upon detection of an auction price about the item from any one of the plurality of second calculating devices within an N^{th} pre-set time, the determining step may comprise:

judging whether the auction price bidden by the second calculating device is a highest auction price within the N^{th} pre-set time and is greater than an auction price bidden successfully within an (N−1)^{th} pre-set time, if so, judging whether the second calculating device has been determined as a successful bidder within the (N−1)^{th}pre-set time, and if not, determining the second calculating as a successful bidder within the N^{th} pre-set time,

where N is a positive integer equal to or greater than 2.

According to an embodiment, an auction price from a second calculating device may be associated with an item information, and the determining step may further comprise: judging whether the item information matches the item in a current auction.

According to an embodiment, the auction method may further comprise: judging whether each of the plurality of second calculating devices is valid before the determining step.

According to an embodiment, judging whether each of the plurality of second calculating devices is valid may comprise: judging whether each of the plurality of second calculating devices has delivered a deposit.

According to an embodiment, the auction method may further comprise:

allocating a grade value to each of the plurality of second calculating devices, and upon determining one of the plurality of second calculating devices as a successful bidder, reducing the grade value of the one of the plurality of second calculating devices; and

if there are more than one second calculating device corresponding to a highest auction price within the N^{th} pre-set time and none of the more than one second calculating device has been determined as a successful bidder within the (N−1)^{th} pre-set time, sorting the more than one second calculating device according to the grade value, and determining the second calculating device having a highest grade value as a successful bidder within the N^{th} pre-set time.

According to an embodiment, the plurality of second calculating devices may communicate with the first calculating device through a long link.

According to an embodiment, a port for establishing the long link for the plurality of second calculating devices may be selected from the group consisting of an 8080 port, a 9090 port and a 443 port.

According to an embodiment, the auction method may further comprise:

sending, by the first calculating device, a shared link address of the item to each of the plurality of second calculating devices, the shared link address being used for displaying an auction information of the item;

acquiring, by the first calculating device, a shared count of each of the plurality of second calculating devices, the shared count being associated with a number of users accessing the shared link address issued by the corresponding second calculating device; and

after the item is sold, giving an additional commission or red envelope to one or more of the plurality of second calculating devices according to the shared counts.

According to an embodiment, the auction method may further comprise: sorting, in a descending order of the shared counts, all the second calculating devices that have issued the shared link address.

According to an embodiment, the additional commission or red envelope may be given to each of top M second calculating devices according to a ranking of the shared counts, where M is a natural number equal to or greater than 1 but is smaller than a number of all the second calculating devices participating in auction of the item

### BRIEF DESCRIPTION OF THE DRAWINGS

FIG. 1 is a flowchart of an auction method in a first embodiment of the present invention.

FIG. 2 is a flowchart of a successful bid judgment method in a second embodiment of the present invention.

FIG. 3 is a flowchart of a method for conducting preview sharing and excitation sharing on auction information of an online item in a third embodiment of the present invention.

### DETAILED DESCRIPTION

The specific implementation manner of the present invention will be described hereinbelow in more detail with the schematic diagrams. The advantages and features of the present invention will be clearer according to the following description and claims. It is important to note that the drawings adopt a simple form and use a non-accurate proportion and are merely intended to conveniently, clearly and auxiliarily illustrate the embodiments of the present invention.

### Embodiment 1

Embodiment 1 of the present invention provides an auction method, for auction of an item, including the following steps: firstly, detecting, by a first calculating device, one or more auction prices from multiple second calculating devices within a pre-set time; when it is detected that at least one second calculating device bids for the item, that is, the at least one second calculating device offers an auction price about the item to the first calculating device, then acquiring and storing, by the first calculating device, the auction price offered by the at least one second calculating device, and determining, by the first calculating device, that one of the at least one second calculating device bids successfully within the pre-set time. The foregoing steps are repeatedly executed until the item is sold or passed. When the item is sold, each of other second calculating devices, except the successful bidder, bidding successfully within each pre-set time will gain a certain amount of commissions or red envelopes.

It is important to note that in the present embodiment, the second calculating device may be various terminals such as a Personal Computer (PC) and various mobile terminals such as an ipad, a laptop and a smart phone having been popularized currently. The first calculating device may be a server, and alternatively, there may be one or more servers. When there are more servers, the multiple servers complete the whole auction process in a distributed manner. Preferably, by means of a distributed locking mechanism, when executing a task in a distributed manner, the multiple servers can conduct mutually exclusive operation, so that the task can be fully executed and cannot be repeatedly executed. Alternatively, in other embodiments of the present invention, the first calculating device and the second calculating device are not limited in such a way.

An auction process of the item includes at least one auction stage. Each auction stage may be configured as at least one of a fixed-price stage, a free-bid stage and a final-bid stage. That is to say, the auction process of the item may include one auction stage, or may include two or more auction stages. Each auction stage includes at least one of a fixed-price stage, a free-bid stage and a final-bid stage. In other words, each auction stage may only include a fixed-price stage, or may only include a free-bid stage or may even only include a final-bid stage. Each auction stage may also include any two of a fixed-price stage, a free-bid stage and a final-bid stage. Each auction stage may also include all of a fixed-price stage, a free-bid stage and a final-bid stage. The number of auction stages included in the auction process of the item and the specific one of the fixed-price stage, the free-bid stage and the final-bid stage included in each auction stage may be configured according to actual requirements. No further detailed description will be made herein.

Specifically, when the auction process includes the fixed-price stage and the free-bid stage, and if a bid from any one of the second calculating devices is equal to or greater than a first pre-set price, the fixed-price stage is switched to the free-bid stage. When the auction process includes the free-bid stage and the final-bid stage, and if a bid from any one of the second calculating devices is equal to or greater than a second pre-set price, the free-bid stage is switched to the final-bid stage. When the auction process includes the fixed-price stage and the final-bid stage, and if a bid from any one of the second calculating devices is equal to or greater than the second pre-set price, the fixed-price stage is switched to the final-bid stage. In other words, the first pre-set price decides a trigger condition for switching the fixed-price stage to the free-bid stage, and the second pre-set price decides a trigger condition for switching the fixed-price stage or the free-bid stage to the final-bid stage. The first pre-set price and the second pre-set price may be pre-set according to, for example, the value of the item and an expected auction rhythm, which will not be limited in the present invention. Usually, the first pre-set price is set to be smaller than the second pre-set price.

In addition to the first pre-set price and the second pre-set price, a reserve price, a cap price and a final bid are probably involved in the auction method of the present invention, and it is determined whether the item is sold or passed according to these three prices. Besides, a final hammer price may be determined according to the cap price and/or the final bid, and details will be presented hereinafter. Generally, the reserve price, the cap price and the final bid may be pre-set according to the value of the item, and usually satisfy that: the reserve price, the cap price and the final bid are successively increased. The reserve price, the cap price and the final bid can be pre-set in many different manners. Since the price setting manner is not what needs to be discussed in the present invention, specific expansion will not be conducted.

According to the present embodiment, the first pre-set price, the second pre-set price, the reserve price, the cap price and the final bid are separately and independently set. The five prices may be set as five different values, or two (e.g., the first pre-set price and the reserve price) of the prices may be set as identical values, which will not be limited in the present invention as long as the auction process can be conducted reasonably and effectively.

Preferably, a grade value will be set for each second calculating device at the initial stage, and every time a bid is successful, the grade value of the second calculating device that currently bids successfully is reduced.

Further, each second calculating device bids an equal raised price each time at the fixed-price stage. All the second calculating devices that have bidden are arranged in a descending order of grade values, and then are arranged according to a bidding time sequence. When within the pre-set time, the highest grade value corresponds to only one second calculating device, the second calculating device is determined to have bidden successfully; and when within the pre-set time, the highest grade value corresponds to multiple second calculating devices, the second calculating device that bids at the soonest within the pre-set time and has the highest grade value is determined to have bidden successfully.

Each second calculating device may bid an equal or unequal raised price each time at the free-bid stage. All the second calculating devices that have bidden are arranged in a descending order of bids; when only one second calculating device is the highest bidder within the pre-set time, the second calculating device is determined to have bidden successfully; when multiple second calculating devices are the highest bidders within the pre-set time, the multiple second calculating devices are arranged in a descending order of grade values; when the highest grade value corresponds to only one second calculating device, the second calculating device is determined to have bidden successfully; and when the highest grade value corresponds to multiple second calculating devices, the multiple second calculating devices are arranged according to a bidding time, and the second calculating device that bids at the soonest within the pre-set time and has the highest grade value is determined to have bidden successfully.

Each second calculating device may bid an equal or unequal raised price each time at the final-bid stage. All the second calculating devices that have bidden are arranged in a descending order of bids; when only one second calculating device is the highest bidder within the pre-set time, the second calculating device is determined to have bidden successfully; when multiple second calculating devices are the highest bidders within the pre-set time, the multiple second calculating devices that are the highest bidders are arranged in a descending order of grade values, and when the highest grade value corresponds to only one second calculating device, the second calculating device is determined to have bidden successfully; and when the highest grade value corresponds to multiple second calculating devices, the multiple second calculating devices having the highest grade value are arranged according to a bidding time, and the second calculating device that bids at the soonest within the pre-set time and has the highest grade value is determined to have bidden successfully. When a bid from a second calculating device is equal to or greater than a final bid, the auction is ended, and the item is sold according to the cap price, that is, a hammer price is equal to the cap price.

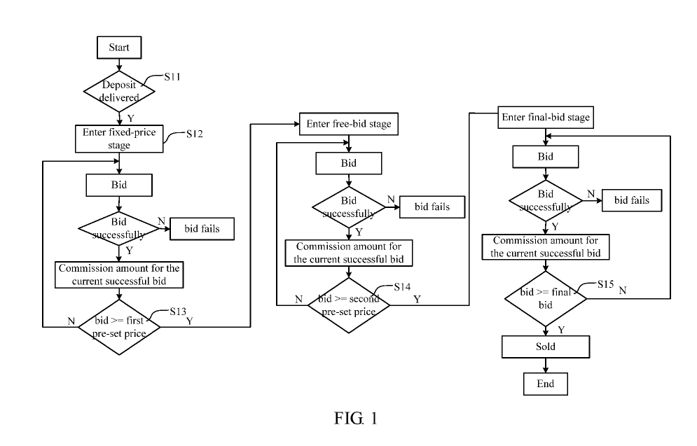

In the present embodiment, for example, the auction process includes the fixed-price stage, the free-bid stage and the final-bid stage, and there are many second calculating devices. As shown in FIG. 1, FIG. 1 is a flowchart of an auction method in the present embodiment of the present invention. It is important to note that the flow shown in FIG. 1 is only one of multiple possible flows of the present invention, and the present invention should not be limited thereto. Besides, in order to highlight the main line of the flow, some branch flows are omitted in FIG. 1. However, a person skilled in the art should be able to directly determine all the possible branch flows beyond all doubt according to the following specific description.

Firstly, the multiple second calculating devices need to bid by paying deposits, at Step S11 in FIG. 1. After the multiple second calculating devices pay the deposits, a grade value is set for each second calculating device, and the grade value has an initial value. The initial values of the grade values of all the second calculating devices may be identical or different. For example, the amounts of the deposits paid by all the second calculating devices can be required to be consistent, and meanwhile, the initial values of the grade values of all the second calculating devices are set to be identical. Likewise, after it is ensured that the amount of the deposit paid by each second calculating device is greater than a certain amount, further limitation is not made. That is, each second calculating device can self-decide the amount of the paid deposit, and the initial value of the grade value thereof may be set according to the amount of the paid deposit. For example, the larger the amount of the paid deposit is, the higher the initial value of the grade value may be. Or, the larger the amount of the paid deposit is, the lower the initial value of the grade value may be. Alternatively, the initial values of the grade values of all the second calculating devices may be equal, regardless of the deposits paid by the second calculating devices. In the present embodiment, the initial value is, for example, 6. In other embodiments of the present invention, the initial value is not limited thereto.

Then, the multiple second calculating devices bid for the item, and enter the fixed-price stage, at Step S12 in FIG. 1. The item has a starting price, the starting price being the lowest price that can be offered for the item by the multiple second calculating devices. Generally, the starting price is equal to or greater than zero. When the pre-set auction period is ended, if the bids from all the second calculating devices are smaller than a reserve price, auction for the item fails, the item is passed, and the deposits are fully returned to all the second calculating devices.

Each second calculating device bids an equal raised price during bidding at the fixed-price stage. For example, the starting price of the item is $10, and the price raised each time is $10. So, each second calculating device can raise the current price of the item by only $10. Therefore, the bids from the multiple second calculating devices are equal within the pre-set time, all the second calculating devices that have bidden within the pre-set time are arranged in a descending order of grade values, when within the pre-set time, the highest grade value corresponds to only one second calculating device, the second calculating device is determined to have bidden successfully; and when within the pre-set time, the highest grade value corresponds to multiple second calculating devices, the second calculating device that bids at the soonest within the pre-set time and has the highest grade value is determined to have bidden successfully. The second calculating device that is determined to have bidden successfully will gain a certain amount of commissions or red envelopes, and the grade value will be reduced accordingly.

The amount of commissions or red envelopes gained by the second calculating device that bids successfully is calculated by the following formula:

Yᵢ=(Cᵢ−C_{cur})×w₁ , (Formula 1)

where i is a positive integer equal to or greater than 1, i is representative of an i^{th} second calculating device, Cᵢ is representative of an auction price bidden successfully by the i^{th} second calculating device, Yᵢ is representative of an amount of commissions or red envelopes gained by the i^{th} second calculating device after bidding successfully, C_{cur} is representative of a current price of the item before the i^{th} second calculating device bids Cᵢ, and w₁ is representative of a pre-set proportion. The value of w₁ is only required to be greater than zero. In the embodiment of the present invention, 2%≤w₁≤10%, and preferably, w₁ is 5%. Alternatively, in other embodiments of the present invention, w₁ may be 7%, 9%, 20% or other values, and will not be limited thereto.

The grade value is reduced whilst the second calculating device that bids successfully gains the amount of commissions or red envelopes. The grade value of a second calculating device may be uniformly reduced after bidding successfully each time. For example, in the present embodiment, an initial value of the grade value is 6, after a first bid is successful, the grade value is reduced to 5, and after a second bid is successful, the grade value is reduced to 4, and so on. Alternatively, in order to avoid the problem that a subsequent bid cannot be offered due to a too small initial value of the grade value, the initial value of the grade value can be set to be sufficiently large, such as 100. The grade value of a second calculating device may also be non-uniformly reduced after bidding successfully each time. For example, when the second calculating device bids successfully at the fixed-price stage, the grade value is reduced by 1 each time. As shown in the previous example, the initial value of the grade value is 6, and after the second calculating device bids successfully once at the fixed-price stage, the grade value is reduced to 5. When the second calculating device bids successfully at the free-bid stage, the grade value is reduced by 2. As shown in the previous example, after the second calculating device bids successfully once at the fixed-price stage and the free-bid stage, respectively, the grade value is reduced to 3. When the second calculating device bids successfully at the final-bid stage, the grade value is reduced by 3. As shown in the previous example, after the second calculating device bids successfully once at each of the fixed-price stage, the free-bid stage and the final-bid stage, the grade value is reduced to 0. Alternatively, in the present embodiment, the grade value of the second calculating device that bids successfully may be reduced in other manners, not limited thereto, so more second calculating devices can participate in the auction process, the opportunity of making other second calculating devices bid successfully is increased, and more second calculating devices can thus gain commissions or red envelopes by means of successful bids. Accordingly, the grade value thereof can be increased by means of a transaction situation and active situation of a user.

Further, a pre-set auction period such as 10 min, 20 min and 30 min is set for the whole auction process, and any limitations will not made in the present invention. The pre-set time is a unit time, that is, the whole auction process is uniformly divided according to the pre-set time. In other words, the pre-set auction period is divided into multiple periods of pre-set time. If none of second calculating devices bids within a certain pre-set time, none of the second calculating devices bids successfully within the pre-set time. If one or more second calculating devices bid within a certain pre-set time, it is determined that only one second calculating device bids successfully according to the foregoing judgment mode. The pre-set time is greater than 0 s, may be, for example, 0.5 s, 1 s, 1.5 s, 2 s or other values, and will not be limited thereto in the present invention. In the present embodiment, the pre-set time is 1 s.

The following judgment is conducted in sequence within the pre-set auction period.

Firstly, it is judged whether the bid from a second calculating device reaches the first pre-set price, at Step S13 in FIG. 1. When the bid from a second calculating device is equal to or greater than the first pre-set price, the fixed-price stage is switched to the free-bid stage. All the second calculating devices that have bidden are arranged in a descending order of bids at the free-bid stage; when only one second calculating device is the highest bidder within the pre-set time, the second calculating device is determined to have bidden successfully; when multiple second calculating devices are the highest bidders within the pre-set time, the multiple second calculating devices are arranged in a descending order of grade values, and when the highest grade value corresponds to only one second calculating device, the second calculating device is determined to have bidden successfully; and when the highest grade value corresponds to multiple second calculating devices, the multiple second calculating devices are arranged according to a bidding time, and the second calculating device that bids at the soonest within the pre-set time and has the highest grade value is determined to have bidden successfully. The amount of commissions or red envelopes gained by the second calculating device that is determined to have bidden successfully at the free-bid stage may be calculated by Formula 1.

Then, it is judged whether the bid from a second calculating device reaches the second pre-set price, at Step S14 in FIG. 1. When the bid from the second calculating device is equal to or greater than the second pre-set price, the free-bid stage is switched to the final-bid stage. All the second calculating devices that have bidden are arranged in a descending order of bids at the final-bid stage; when only one second calculating device is the highest bidder within the pre-set time, the second calculating device is determined to have bidden successfully; when multiple second calculating devices are the highest bidders within the pre-set time, the multiple second calculating devices that are the highest bidders are arranged in a descending order of grade values, and when the highest grade value corresponds to only one second calculating device, the second calculating device is determined to have bidden successfully; and when the highest grade value corresponds to multiple second calculating devices, the multiple second calculating devices having the highest grade value are arranged according to a bidding time, and the second calculating device that bids at the soonest within the pre-set time and has the highest grade value is determined to have bidden successfully. The amount of commissions or red envelopes gained by the second calculating device that is determined to have bidden successfully at the final-bid stage may also be calculated by Formula 1.

As another possible flow, if the price raising rate is not specially limited at the fixed-price stage and the bid from a certain second calculating device is equal to or greater than the second pre-set price, the fixed-price stage is directly switched to the final-bid stage.

Further, it is also judged whether the bid from a second calculating device reaches the final bid at the final-bid stage, at Step S15 in FIG. 1. When the bid from the second calculating device is equal to or greater than the final bid, the item is sold. In this case, commissions or red envelopes gained by each of other second calculating devices, except the successful buyer, bidding successfully may be calculated by Formula 1.

Similarly, as another possible flow, if the price raising rate is not specially limited at the fixed-price stage or the free-bid stage and the bid from a certain second calculating device is equal to or greater than the final bid, the item is directly sold.

When the pre-set auction period expires, if the auction is still at the fixed-price stage and none of the bids from the second calculating devices reaches the reserve price, the item is passed. Otherwise, if any one of the second calculating devices has bidden a price equal to or higher than the reserve price (in such a case, the auction usually enters the free-bid stage or the final-bid stage), the item is sold after expiration of the pre-set auction period.

A hammer price of the item and a payment needing to be made by the second calculating device that is the successful buyer are slightly different according to different auction stages and auction prices during hammer dropping. Details are as follows.

a) When a reserve price is smaller than or equal to an auction price during hammer dropping (i.e. a bid from a second calculating device during hammer dropping), which is smaller than a cap price, a payment needing to be made by a second calculating device that is the successful buyer is calculated by the following formula:

C_{pay}=C₁ , (Formula 2)

where C_{pay} is representative of payment needing to be made by the second calculating device that is the successful buyer, and C₁ is representative of the auction price during hammer dropping, that is, a hammer price of the item. In this case, the payment needing to be made by the second calculating device that is the successful buyer is equal to the hammer price of the item.

b) When a cap price is smaller than or equal to an auction price during hammer dropping (i.e. a bid from a second calculating device during hammer dropping), which is smaller than a final bid, a payment needing to be made by the second calculating device that is the successful buyer is calculated by the following formula:

C_{pay}−C_{cap}+(C₁−C_{cap})×w₂ , (Formula 3)

where C_{pay} is representative of the payment needing to be made by the second calculating device that is the successful buyer, C₁ is representative of the auction price during hammer dropping, that is, a hammer price of the item, C_{cap} is representative of the cap price, and w₂ is representative of a pre-set proportion, which may be identical to or different from w₁, no limitations being made in the present invention. The (C₁−C_{cap})×w₂ may be interpreted as a service charge, and therefore a payment actually made by the second calculating device that is the successful buyer is equal to a sum of the hammer price and the service charge.

c) When an auction price during hammer dropping (i.e. a bid from a second calculating device during hammer dropping) is equal to or greater than a final bid, the item is sold according to a cap price, that is, a hammer price of the item is equal to the cap price, and a payment needing to be made by the second calculating device that is the successful buyer is calculated by the following formula:

C_{pay}=C_{cap}+(C_{final}−C_{cap})×w₃ , (Formula 4)

where C_{pay} is representative of the payment needing to be made by the second calculating device that is the successful buyer, C_{final} is representative of the final bid, C_{cap} is representative of the cap price, and w₃ is representative of a pre-set proportion, which may be identical to or different from w₁, no limitations being made in the present invention. The (C_{final}−C_{cap})×w₃ may be interpreted as a service charge, and therefore a payment actually made by the second calculating device that is the successful buyer is equal to a sum of the hammer price and the service charge.

Commissions or red envelopes given to each second calculating device that bids successfully may be paid through at least part of the service charge, or may be paid by an operator corresponding to the first calculating device. No limitations are made in the present invention.

To sum up, in the auction method provided according to embodiment 1 of the present invention, a user implements online item transaction through a second calculating device, thus lowering the threshold for a common user to participate in auction. Meanwhile, in an auction process, a user who bids successfully can also gain a certain amount of commissions or red envelopes according to a price bidden by the user, thus increasing the participation enthusiasm of a user for online auction, and increasing the efficiency of item auction.

### Embodiment 2

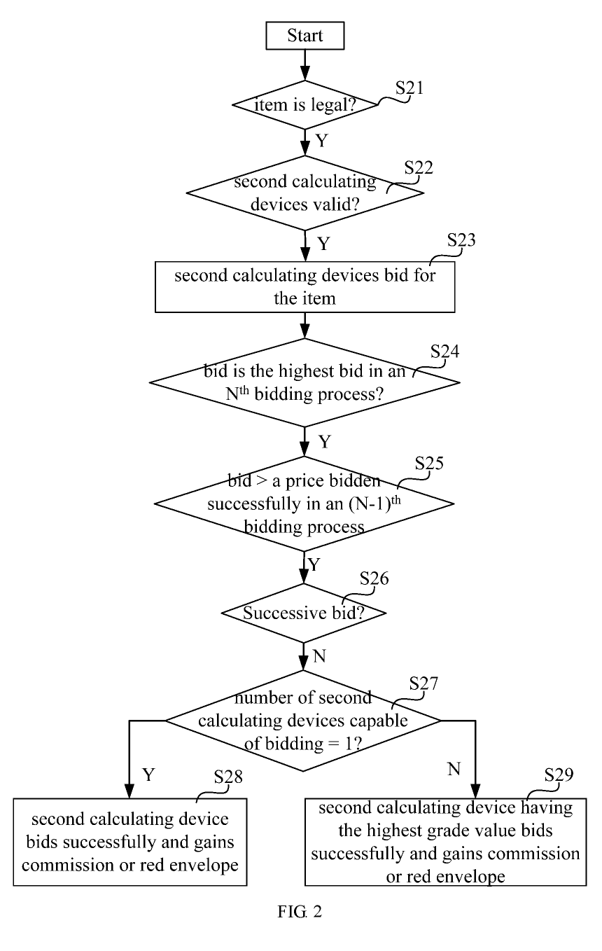

On the basis of embodiment 1, in order to increase the probability of each second calculating device for bidding successfully and gaining relevant commissions or red envelopes to increase the participation enthusiasm of each second calculating device for auction, embodiment 2 of the present invention further specifies a successful bid determination mode in the auction method. Specifically, as shown in FIG. 2, FIG. 2 is a flowchart of a successful bid judgment method in a second embodiment of the present invention. The method includes the following steps.

Firstly, when a bid from a second calculating device for the item is received, it is necessary to judge whether the item is legal, at Step S21 in FIG. 2. Specifically, each item has a specific identification (ID), and before auction for the item is started, it is necessary to identify the ID of the current item to make it distinguished from other items so as to avoid wrong bids for other items during bidding for the current item, i.e., to avoid wrong bids from the multiple second calculating devices for other items during bidding for the current item. For this purpose, when the first calculating device receives an auction price from a second calculating device, it is necessary to judge whether the ID of the item associated with the auction price conforms to the ID of the current item in auction, if so, a next step is executed, and otherwise, an error is sent to the second calculating device.

Then, it is judged whether the multiple second calculating devices participating in bidding for the item are valid, at Step S22 in FIG. 2, and a prompt about non-validness is sent to the invalid second calculating device.

Specifically, the standard for judging whether the multiple second calculating devices are valid includes, but not limited to, judging whether the multiple second calculating devices have delivered deposits. After the multiple second calculating devices have delivered the deposits, a grade value is set for each second calculating device, the grade value having an initial value. The initial values of the grade values of all the second calculating devices may be identical or different. For example, the amounts of the deposits delivered by all the second calculating devices may be required to be consistent, and meanwhile, the initial values of the grade values of all the second calculating devices are set to be identical. Likewise, after it is ensured that the amount of the deposit delivered by each second calculating device is greater than a certain amount, further limitation is not made. The initial values of the grade values of all the second calculating devices may be equal, regardless of the deposits delivered by the second calculating devices. In the present embodiment, the initial value is, for example, 6. In other embodiments of the present invention, the initial value is not limited thereto. Then, the multiple valid second calculating devices offer, to the first calculating device, bids for the item, at Step S23 in FIG. 2.

The multiple second calculating devices communicate with the first calculating device through long links. Specifically, ports for establishing the long links for the multiple second calculating devices include, but not limited to, an 8080 port, a 9090 port and a 443 port.

In an N^{th} bidding process for the item (corresponding to an N^{th} pre-set time), it is judged whether the bid from any one of the multiple second calculating devices is the highest bid in the N^{th} bidding process, at Step S24 in FIG. 2, where N is a positive integer equal to or greater than 2. When the bid is the highest bid in the N^{th} bidding process, Step S25 is executed.

In Step S25, it is judged whether the highest bid in the N^{th} bidding process is greater than a price bidden successfully in an (N−1)^{th} bidding process (within an (N−1)^{th} pre-set time). When the highest bid in the N^{th} bidding process is greater than the price bidden successfully in the (N−1)^{th} bidding process, Step S26 is executed.

In Step S26, it is judged whether the second calculating device that is the highest bidder in the N^{th} bidding process bids successfully in the (N−1)^{th} bidding process.

In order to avoid successful bidding of a second calculating device for the same item for two successive times, it is necessary to judge whether the second calculating device that is the highest bidder in the N^{th} bidding process bids successfully in the (N−1)^{th} bidding process. When bidding successfully in the (N−1)^{th} bidding process, the second calculating device cannot bid in the N^{th} bidding process. When the second calculating device does not bid successfully in the (N-1)^{th} bidding process, the second calculating device is allowed to bid in the N^{th} bidding process. Then, Step S27 is executed.

In Step S27, it is judged whether there is one or more second calculating devices capable of bidding in Step S26.

When there is only one second calculating device capable of bidding in Step S26, the second calculating device is determined to have bidden successfully, will gain commissions or red envelopes in the N^{th} bidding process, and informs other second calculating devices, participating in the item auction, of the content including, but not limited to, that the second calculating device has bidden successfully and the second calculating device has gained the commissions or red envelopes in the N^{th} bidding process.

Meanwhile, the grade value of the second calculating device that bids successfully is reduced, at Step S28 in FIG. 2.

When there are multiple second calculating devices capable of bidding in Step S26, that is to say, when multiple second calculating devices are the highest bidders in the N^{th} bidding process, bids of the multiple second calculating devices are all higher than a price bidden successfully in the (N−1)^{th} bidding process and none of the multiple second calculating devices has bidden successively in the (N−1)^{th} bidding process, the multiple second calculating devices are sorted in a descending order of grade values, a second calculating device having the highest grade value is determined to have bidden successfully, and the second calculating device having the highest grade value will gain commissions or red envelopes in the N^{th} bidding process, and informs other second calculating devices, participating in the item auction, of the content similarly including, but not limited to, that the second calculating device has bidden successfully. Then, the grade value of the second calculating device having the highest grade value is reduced, at Step S29 in FIG. 2.

Step S23 to Step S29 are repeatedly executed until the item is sold or passed.

In the present embodiment, the amount of the commissions or red envelopes gained by the second calculating device that bids successfully is obtained by Formula 1 in Embodiment 1. No detailed description is made herein.

In the present embodiment, users bid for the item on the multiple second calculating devices through an application program. When a second calculating device bids successfully, the user using the second calculating device through the application program will gain corresponding red envelopes or commissions.

To sum up, in the successful bid judgment method provided in the present embodiment, in an N^{th} bidding process for an item, only when a second calculating device is the highest bidder and bids a price higher than a price bidden in an (N−1)^{th} bidding process and, further, the second calculating device does not successfully bid in the (N−1)^{th} bidding process, the second calculating device will be determined to successfully bid in the N^{th} bidding process so as to avoid successful bidding of a second calculating device for two successive times. The second calculating device that bids successfully each time will gain commissions or red envelopes, so the probability of each second calculating device for bidding successfully and gaining relevant commissions or red envelopes can be increased, thus increasing the participation enthusiasm of each second calculating device for auction.

### Embodiment 3

In order to increase the popularity of an item to attract more people to participate in an auction to further expand the audience scope of the item in an auction process, the present invention also provides a method for conducting preview sharing and excitation sharing on auction information of an online item on the basis of embodiment 1 or 2.

Specifically, an online auction process for an item may include the following processes: a preparation stage of auction for the item, a formal auction stage and an auction ending stage. At the preparation stage of auction for the item, a user desiring to participate in online auction for the item can implement auction for the item through an application program installed on a calculating device.

It is important to note that the calculating device includes, but not limited to, various mobile terminals, and preferably, in the present embodiment, the calculating device includes a smart phone.

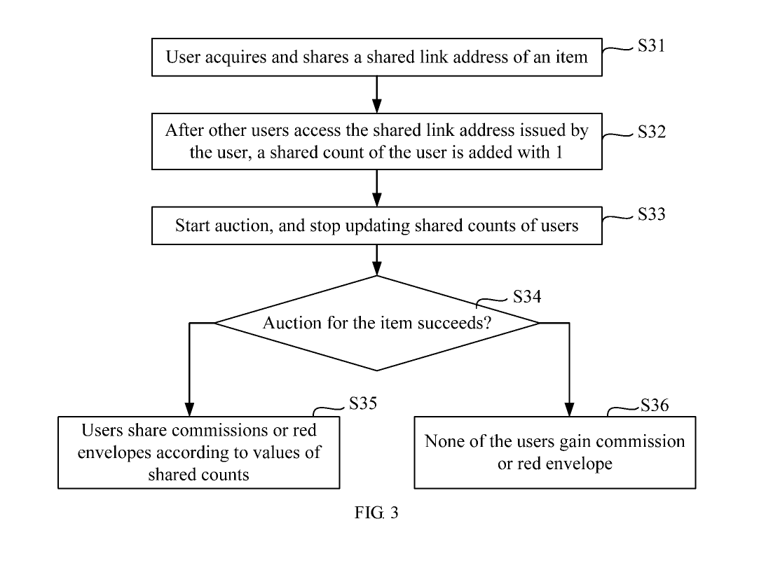

After paying a certain amount of deposit, the user enters the preparation stage of auction for the item. At the preparation stage, a user may acquire a shared link address of the item and may share the shared link address through various social platforms. Meanwhile, a shared count is set for the user, and an initial value of the shared count is set as 0, at Step S31 in FIG. 3. FIG. 3 is a flowchart of a method for conducting preview sharing and excitation sharing on auction information of an online item in a third embodiment of the present invention.

In other words, after paying a certain amount of deposit, the user may issue information of the item to various social platforms. The social platforms include, but not limited to, various existing social sharing platforms such as WeChat, QQ, Weibo, Zhihu and other various existing social platforms. Alternatively, the social platforms are not limited thereto in the present embodiment. In other embodiments of the present invention, other social platforms are also included, such as Twitter, Facebook and Linkedin, so as to increase the popularity of the item and to increase the popularity of the application program used by the user, thus making more people know the item and able to participate, through the application program, in auction activities of the item or other items, and further expanding the audience scope of the auction process for the item.

Specifically, a user who shares the item shares a link address on accounts of various social platforms, and the link address can be linked to a network address where various pieces of information of the item are publicized. All users who participate in auction for the item can send shared link addresses on various social platforms.

After other users in the various social platforms access the shared link address shared by the user who shares the item, a shared count of the user who issues the shared link address is added with 1, at Step S32 in FIG. 3.

Taking user A as an example for each user who issues the shared link address, the user A issues the shared link address on various social platforms. For example, the user A issues the shared link address through accounts thereof on WeChat, QQ and Weibo separately. When one of other users on a social platform accesses the shared link address through the shared link address issued by the user A, a shared count of the user A is added with 1. For example, a user B has accounts on WeChat, QQ and Weibo separately, and can access, on the three social platforms, information issued on the three social platforms by the user A. When the user B accesses the shared link address issued on WeChat by the user A through WeChat, the shared count of the user A is added with 1. Besides, the user B also accesses the shared link address issued on QQ by the user A through QQ, so the shared count of the user A is added again with 1. Further, the user B also accesses the shared link address issued on Weibo by the user A through Weibo, so the shared count of the user A is added again with 1. In this example, the shared count of the user A is updated to 3 through access to the three social platforms.

At the preparation stage, the shared count of each user is continuously updated according to the issued shared link address accessed by other users until the formal auction stage is entered. That is to say, when auction for the item is started, update of the shared count of each user is stopped, the value of the shared count of each user is saved, and all the users are sorted according to the values of the shared counts of all the users, at Step S33 in FIG. 3.

Specifically, all the users are sorted in a descending order of shared counts of all the users. However, no limitations are made in the present embodiment. In other embodiments of the present invention, all the users are sorted in an ascending order of shared counts of all the users. No detailed description is made herein.

Then, the formal auction stage is entered, auction can be conducted according to the process (or only part of the process) described in embodiment 1 or 2, corresponding step descriptions being omitted herein. After auction for the item is ended, it is necessary to judge whether the auction for the item succeeds, at Step S34 in FIG. 3.

Specifically speaking, when the auction for the item succeeds, users may share commissions or red envelopes according to the value of the shared count, at Step S35 in FIG. 3. Specifically, in the present embodiment, all users whose shared counts are greater than 0 may gain a certain amount of commissions or red envelopes according to the values of the shared counts. In other embodiments of the present invention, as reward measures, commissions or red envelopes are only provided for users having a larger value of the shared count. For example, after the shared counts of all the users are arranged in a descending order, commissions or red envelopes are only provided for the top N users, the values of commissions or red envelopes of other users are zero, and top users will gain more commissions or red envelopes, where N is a natural number equal to or greater than 1.

Specifically, the commissions or red envelopes of each user may be calculated by the following formula:

Yᵢ=profit×w₄×Pi , (Formula 5)

where Yᵢ is representative of commissions or red envelopes of an i^{th} user, a profit refers to a profit of an institution in auction for the item, w₄ is representative of a pre-set proportion, and refers to that a certain proportion of the institution in an auction profit for the item is used as commissions or red envelopes of each user, and Pi is representative of a bonus proportion of the i^{th} user.

In the present embodiment, for example, commissions or red envelopes are provided for the top M users. Specifically, in the process of providing commissions or red envelopes for the M users, the users are divided into only two levels, that is, the top K users among the top M users are in a level, and the proportions of the K users are consistent, where 1≤K≤M. In one embodiment, K may be 3, and M may be 100.

In other embodiments of the present invention, in the process of providing commissions or red envelopes for the M users, the users may be divided into three or more levels. For example, the users are divided into three levels, where the bonus proportion of the first user is P1, the bonus proportions of both the second user and the third user are P2, and the bonus proportions of the remaining (M−3) users are P3. Specifically, in one embodiment, P1 is 10%, P2 is 5%, and the remaining (M-3) users share the rest 80%. In other embodiments of the present invention, the bonus proportions are not limited thereto, and may be bonuses in other forms, and no detailed description will be made herein.

When the auction for the item fails, that is, when the item is passed, all the users cannot gain commissions or red envelopes, at Step S36 in FIG. 3.

To sum up, in the method for conducting preview sharing and excitation sharing on auction information of an online item provided in the present embodiment, any one of users who participate in auction for an item can issue a shared link address of the item to various social platforms. When another user accesses the shared link address through the various social platforms, the value of a shared count of the user is added with 1. When the item is sold, each user can gain a certain amount of commissions or red envelopes according to the value of the shared count thereof, the enthusiasm of each user for issuing the shared link address about the item can be aroused, the popularity of the item is increased in a sharing process, and moreover, the popularity of an application program for auction of the item can be also increased, thus expanding the audience scope of the item in the auction process.

The above is only the preferable embodiments of the present invention, and not intended to make any limitations on the present invention. Any changes such as equivalent replacements or modifications in any form, made by a person skilled in the art, to the technical solution and the technical content disclosed in the present invention without departing from the scope of the technical solution of the present invention belong to the content of the technical solution not departing from the present invention and still fall within the scope of protection of the present invention.

What is claimed is:

1. An auction method, for auction of an item, comprising:
detecting, by a first calculating device, one or more auction prices from a plurality of second calculating devices within a pre-set time;
upon detection of at least one auction price, determining one of the plurality of second calculating devices as a successful bidder within the pre-set time; and
repeating the foregoing steps until the item is sold or passed, wherein
when the item is sold, the method further comprises: giving a commission or a red envelope to each second calculating device that has been determined as a successful bidder within a corresponding pre-set time except the second calculating device to which the item is sold.

2. The auction method of claim 1, wherein an auction process of the item comprises one or more of a fixed-price stage, a free-bid stage and a final-bid stage.

3. The auction method of claim 2, further comprising:
allocating a grade value to each of the plurality of second calculating devices, and upon determining one of the plurality of second calculating devices as a successful bidder, reducing the grade value of the one of the plurality of second calculating devices.

4. The auction method of claim 3, wherein during the fixed-price stage, the plurality of second calculating devices are only allowed to bid auction prices that are equally raised; and
the determining step comprises:
sorting, in a descending order of the grade values, all the second calculating devices that have bidden within the pre-set time;
if there is only one second calculating device corresponding to a highest grade value, the only one second calculating device corresponding to the highest grade value is determined as a successful bidder;
otherwise, further sorting the second calculating devices corresponding to the highest grade value according to a bidding time, and determining the second calculating device that bids soonest within the pre-set time and has the highest grade value as a successful bidder.

5. The auction method of claim 3, wherein during the free-bid stage, the plurality of second calculating devices are allowed to bid auction prices that are equally or unequally raised; and
the determining step comprises:
sorting, in a descending order of auction prices, all the second calculating devices that have bidden within the pre-set time;
if there is only one second calculating device corresponding to a highest auction price, the only one second calculating device corresponding to the highest auction price is determined as a successful bidder;
otherwise, further sorting, in a descending order of grade values, the second calculating devices corresponding to the highest auction price;
if there is only one second calculating device corresponding to a highest grade value, the only one second calculating device corresponding to the highest grade value is determined as a successful bidder;
otherwise, further sorting the second calculating devices corresponding to the highest grade value according to a bidding time, and determining the second calculating device that bids soonest within the pre-set time and has the highest grade value as a successful bidder.

6. The auction method of claim 3, wherein during the final-bid stage, the plurality of second calculating devices are allowed to bid auction prices that are equally or unequally raised; and
the determining step comprises:
sorting, in a descending order of auction prices, all the second calculating devices that have bidden within the pre-set time;
if there is only one second calculating device corresponding to a highest auction price, the only one second calculating device corresponding to the highest auction price is determined as a successful bidder;
otherwise, further sorting, in a descending order of grade values, the second calculating devices corresponding to the highest auction price;
if there is only one second calculating device corresponding to a highest grade value, the only one second calculating device corresponding to the highest grade value is determined as a successful bidder;
otherwise, further sorting the second calculating devices corresponding to the highest grade value according to a bidding time, and determining the second calculating device that bids soonest within the pre-set time and has the highest grade value as a successful bidder.

7. The auction method of claim 1, wherein upon any one of the plurality of second calculating devices bidding an auction price that is equal to or greater than a final bid, the item is sold; or
upon expiry of a pre-set auction period, if at least one of the plurality of second calculating devices has bidden an auction price that is equal to or greater than a reserve price, and none of the plurality of second calculating devices has bidden an auction price that reaches a cap price, the item is sold; or
upon expiry of a pre-set auction period, if at least one of the plurality of second calculating devices has bidden an auction price that is equal to or greater than a cap price, and none of the plurality of second calculating devices has bidden an auction price that reaches a final bid, the item is sold; or
upon expiry of a pre-set auction period, if none of the plurality of second calculating devices has bidden an auction price that reaches a reserve price, the item is passed.

8. The auction method of claim 2, wherein when the auction process comprises the fixed-price stage and the free-bid stage, upon any one of the plurality of second calculating devices bidding an auction price that is equal to or greater than a first pre-set price, the fixed-price stage ends and the free-bid stage starts.

9. The auction method of claim 2, wherein when the auction process comprises the free-bid stage and the final-bid stage, upon any one of the plurality of second calculating devices bidding an auction price that is equal to or greater than a second pre-set price, the free-bid stage ends and the final-bid stage starts.

10. The auction method of claim 2, wherein when the auction process comprises the fixed-price stage and the final-bid stage, upon any one of the plurality of second calculating devices bidding an auction price that is equal to or greater than a second pre-set price, the fixed-price stage ends and the final-bid stage starts.

11. The auction method of claim 1, wherein an amount of the commission or red envelope given to each second calculating device that has been determined as a successful bidder within a corresponding pre-set time except the second calculating device to which the item is sold is calculated according to:
Yᵢ=(Cᵢ−C_{cur})×w₁,
where i is a positive integer equal to or greater than 1, i represents an i^{th} second calculating device of the plurality of second calculating devices, Ci represents an auction price bidden by the i^{th} second calculating device when the i^{th} second calculating device is determined as a successful bidder, Yᵢ represents an amount of commission or red envelope gained by the i^{th} second calculating device that has been determined as a successful bidder, C_{cur} represents a current price of the item before the i^{th} second calculating device bids Cᵢ, and w₁ represents a pre-set proportion.

12. The auction method of claim 7, wherein when the item is sold,
if a highest auction price bidden among the plurality of second calculating devices is equal to or greater than the reserve price and is smaller than the cap price, an amount of payment by the second calculating device to which the item is sold is calculated according to:
C_{pay}=C₁,
where C_{pay} represents the amount of payment by the second calculating device to which the item is sold, and C₁ represents the highest auction price bidden among the plurality of second calculating devices;
if the highest auction price bidden among the plurality of second calculating devices is equal to or greater than the cap price and is smaller than the final bid, the amount of payment by the second calculating device to which the item is sold is calculated according to:
C_{pay}=C_{cap}+(C₁−C_{cap})×w₂,
where C_{pay} represents the amount of payment by the second calculating device to which the item is sold, C₁ represents the highest auction price bidden among the plurality of second calculating devices, C_{cap} represents the cap price, and w₂ represents a pre-set proportion.

13. The auction method of claim 7, wherein if any one of the plurality of second calculating devices has bidden an auction price that is equal to or greater than a final bid, an amount of payment by the second calculating device to which the item is sold is calculated according to:
C_{pay}=C_{cap}+(C_{final}−C_{cap})×w₃,
where C_{pay} represents the amount of payment by the second calculating device to which the item is sold, C_{final} represents the final bid, C_{cap} represents the cap price, and w₃ represents a pre-set proportion.

14. The auction method of claim 1, wherein upon detection of an auction price about the item from any one of the plurality of second calculating devices within an N^{th} pre-set time, the determining step comprises:
judging whether the auction price bidden by the second calculating device is a highest auction price within the N^{th} pre-set time and is greater than an auction price bidden successfully within an (N−1)^{th} pre-set time, if so, judging whether the second calculating device has been determined as a successful bidder within the (N−1)^{th} pre-set time, and if not, determining the second calculating as a successful bidder within the N^{th} pre-set time,
where N is a positive integer equal to or greater than 2.

15. The auction method of claim 1, wherein an auction price from a second calculating device is associated with an item information, and the determining step further comprises: judging whether the item information matches the item in a current auction.

16. The auction method of claim 1, further comprising:
judging whether each of the plurality of second calculating devices is valid before the determining step.

17. The auction method of claim 16, wherein judging whether each of the plurality of second calculating devices is valid comprises:
judging whether each of the plurality of second calculating devices has delivered a deposit.

18. The auction method of claim 14, further comprising:
allocating a grade value to each of the plurality of second calculating devices, and upon determining one of the plurality of second calculating devices as a successful bidder, reducing the grade value of the one of the plurality of second calculating devices; and
if there are more than one second calculating device corresponding to a highest auction price within the N^{th} pre-set time and none of the more than one second calculating device has been determined as a successful bidder within the (N−1)^{th} pre-set time, sorting the more than one second calculating device according to the grade value, and determining the second calculating device having a highest grade value as a successful bidder within the N^{th} pre-set time.

19. The auction method of claim 1, wherein the plurality of second calculating devices communicate with the first calculating device through a long link.

20. The auction method of claim 19, wherein a port for establishing the long link for the plurality of second calculating devices is selected from the group consisting of an 8080 port, a 9090 port and a 443 port.

21. The auction method of claim 1, further comprising:
sending, by the first calculating device, a shared link address of the item to each of the plurality of second calculating devices, the shared link address being used for displaying an auction information of the item;
acquiring, by the first calculating device, a shared count of each of the plurality of second calculating devices, the shared count being associated with a number of users accessing the shared link address issued by the corresponding second calculating device; and
after the item is sold, giving an additional commission or red envelope to one or more of the plurality of second calculating devices according to the shared counts.

22. The auction method of claim 21, further comprising:
sorting, in a descending order of the shared counts, all the second calculating devices that have issued the shared link address.

23. The auction method of claim 21, wherein the additional commission or red envelope is given to each of top M second calculating devices according to a ranking of the shared counts, where M is a natural number equal to or greater than 1 but is smaller than a number of all the second calculating devices participating in auction of the item.
